(19) United States
(12) Patent Application Publication
(10) Pub. No.: US 2006/0011414 A1
(43) Pub. Date: Jan. 19, 2006

(54) Mounting plate for harness

(76) Inventor: Peter Sundman, Vallda (SE)

Correspondence Address: YOUNG & THOMPSON, 745 SOUTH 23RD STREET, 2ND FLOOR, ARLINGTON, VA, 22202, US

(21) Appl. No.: 10/526,362

(22) PCT Filed: Sep. 1, 2003
(86) PCT No.: PCT/SE03/01348

§ 371 Date: Mar. 2, 2005

(30) Foreign Application Priority Data
Sep. 2, 2002 (SE) 0202600-3

(51) Int. Cl. A62B 1/16

(52) U.S. Cl. 182/6

(57) ABSTRACT

The present invention relates to a mounting plate (1) intended for use together with a harness (2). The mounting plate (1) comprises a first opening (8). The invention is characterized in that the mounting plate (1), via the first opening, is arranged in such a way that, when in use, it juts out essentially at right angles from the body of a user (10). The invention also relates to a safety device comprising a mounting plate (1) and a harness (2).

### TECHNICAL FIELD

The invention relates to a mounting plate intended for use together with a harness. The mounting plate further comprises a first opening. The invention also relates to a safety device comprising a mounting plate and a harness.

### BACKGROUND ART

A harness is used to secure persons who are working at a great height or as an aid for persons who are carrying out a job hanging from a rope, for example on the outside of a building facade, or in a telecommunications mast, or from a rescue helicopter. A harness consists of a number of straps, which are strapped at suitable points around the body of user. A leg strap is strapped around each leg and a waist strap is strapped around the waist of a user. The leg straps and the waist strap are coupled together by additional straps or cords. The harness can further be equipped with shoulder straps extending from one side of the waist strap, across the shoulders and back to the other side of the waist strap. The harness can further be equipped with transverse straps which connect the shoulder straps one to the other across, for example, the shoulder blades and/or across the chest.

The waist part is normally divided into two waist parts on the front side of the harness to make it possible to adjust the size of the waist part around a user. A harness is further equipped with a coupling device in the form of, for example, a so-called D-ring or a specially arranged coupling strap. The D-ring consists of a metallic ring configured with a flat side and a semicircle. The coupling strap usually consists of a strap or band made of durable material. The coupling device is firmly anchored in the leg parts and in the waist part. The coupling device can be anchored to the various parts by straps or the like. When the waist part and the leg parts are strapped around the user, it is possible for the user to secure a variety of devices in the coupling device to allow him to work freely hanging from a rope.

When working hanging from a rope, it is important to be able to adjust one's height according to requirement. A user must therefore be able to lower himself down, stop at a certain height and also be able to gain height.

In lowering operations, there are a large number of lowering gears available which have the task of receiving the rope in a special loop which allows the user to be able to lower himself down with the aid of the rope and halt the lowering operation whenever he wishes. Furthermore, the lowering gear generally allows the facility to lock the rope at the desired height, for example by the rope being clamped in a special device or the rope being fitted in such a loop that the friction in the loop is sufficiently high for the rope not to move. In order to be able to stop at a certain height, there are therefore a large number of devices which stop the rope from sliding once it has been fastened in the device.

In those cases in which the user wishes to gain height in the rope, there are separate winches. The winches can be of both the manual and motor-driven type and can be fixed in connection with the harness. The motor-driven winches are normally fairly large and cumber some, so that it is especially important for the winch to be arranged in such a way near to the harness that the user can easily get at rope, tools and lowering devices.

In order to secure rope, tools, lowering devices, winches, etc. in the harness, a lockable snap hook or other lockable and reclosable device is often used. The snap hook is drawn through the opening in the coupling device (for example the D-ring). A problem arises when a plurality of snap hooks are secured in the opening in the coupling device, since all the devices which are secured in the opening in the coupling device have to share the space in the opening. Unwelcome situations can then arise, in which the securing devices of the various devices are jammed against one another when the user is hanging from the rope. If, for example, a D-ring is used, the securing devices of the tools will slide in the gravitational direction and come together at the lowest point, whereupon the securing devices are jammed. This gives the user problems when one or more devices are to be taken off or moved from the opening in the coupling device.

In order to facilitate the securement of the various tools and devices, a mounting plate can be used. The mounting plate usually consists of a plate with holes/openings. The mounting plate is secured in a snap hook, which, in turn, is secured in the coupling device. One problem with the mounting plate is that the distance between the coupling device and the tool increases, which can give rise to an excessively high working height for a user.

The mounting plate can further be used to secure tools and other devices which the user might need to use during his exercise. When a user is to carry out a job over a lengthy period hanging from the harness, it is of utmost importance that the tools or devices disposed by the mounting plate are in an ergonomically favourable position.

The coupling device is usually arranged in the harness in such a way that the coupling device has an extension along the front side of the user. This is particularly apparent where the coupling device consists of a D-ring. When a snap hook is secured in the coupling device, the snap hook will jut out from the body of a user. The mounting plate which is secured in the snap hook will then, in turn, have an extension along the front side of the user.

The extension of the mounting plate along the body of the user means that the securement points for the various tools and devices lie in the plane along the body of the user. This can be inappropriate, since tools and devices of different weight, placed on different sides of the mounting plate, can create an uneven distribution of loads in the mounting plate. This has an adverse effect upon the user, since the user might lean to one side. It leads to further problems, moreover, when a tool is to be added to or removed from the mounting plate, since further uneven load can then occur. The tools will therefore advantageously be situated on a line out from the body of the user, since an uneven distribution of loads in such a direction will only turn the user toward or away from the rope and not to the side. If a mounting plate of the above-described type is used when tools and devices are placed in front of the mounting plate, the securing devices (snap hooks) of the various tools and devices will cross one another and are therefore at risk of jamming one another.

Once the harness is arranged securely and comfortably around the user, the mounting plate can be used to secure a rope from which the user can hang during use. The rope can further be secured in a lowering gear and a winch. If the mounting plate is secured in a snap hook secured in the coupling device, the lowering gear and the winch will be secured in an opening in the opposite side of the mounting plate.

The user hanging from the rope will have the facility to reach both the lowering gear and the winch so as to be able to determine when he will be lowered down and winched up. In most winches, the rope has to be released from the winch in order for the lowering gear to be operative. One problem with the aforementioned arrangement having the coupling device, the snap hook, the mounting plate, the winch and the lowering gear is that the distance between the coupling device and, for example, the winch is large. The distance is so large that a user disadvantageously and unergonomically has to stretch with his arms at least above shoulder height in order to get to release the rope for lowering or arrange the rope for winching. Furthermore, the winch, the lowering gear and other devices are usually secured in the mounting plate by snap hooks, which further adds to the unwanted height.

Further drawbacks with a device according to the above, having coupling device, snap hook, mounting plate, winch and lowering gear, are that a user is unable to reach the object to be manipulated. Such an object can be a pipe in need of inspection or measurement, or a structure in need of repair or inspection, or some other device in which hanging work is called for. The unwanted height can be so great that the harness does not reach up to the desired object.

The mounting plates which have been described above do not therefore allow an ergonomically favourable position of the type which is sought in hanging work situations.

Further problems with the prior art are that the coupling device, for example the D-ring, can turn, depending on how the loads are distributed over the D-ring from the various straps. Furthermore, the coupling device is secured at the junction between the leg straps and the waist parts and is therefore placed close to the pelvis or lower abdominal region of the user and can irritate the genitalia of a user. When a tool is secured in the coupling device, the securement point of the tool will be located close to the genitalia of the user, which can further impact negatively upon the genitalia of the user.

WO 02/28482 shows a harness having a coupling device in the form of a strap. Extending between the leg parts, moreover, is a connecting strap. The coupling device connects the leg parts to the waist part by the connecting strap. A coupling device according to WO 02/28482 has the problems which have previously been discussed with snap hooks/tools secured in the coupling device, and with mounting plates. The coupling device can thus turn disadvantageously under uneven distribution of loads. If a mounting plate, furthermore, is to be secured in the coupling device, this is done by means of a snap hook, so that an undesirably large distance is formed between the coupling device and a tool.

When a job is to be carried out in a hanging position, it is of utmost importance that all the tools end up in an favourable position for the user. The user sitting in the harness will advantageously have the securement point for tools as low as possible so that the tools end up preferably at stomach/chest height, or level with the solar plexus, or level with the shoulders/head, and at a distance from the body. One advantage with such a positioning of the securement point for tools is that it is easier to reach the tools without needing to place an unhealthy strain upon the shoulders, arms and back. Furthermore, such a securement point allows a reduction in the height of the object to be manipulated. The aforementioned harnesses with coupling device and mounting plate have no such favourable securement point for tools.

A description has been given above of the facility for securing tools directly in the coupling device in order to reduce the height between the coupling device and the tool, which creates problems with the securing devices of the tools becoming jammed. There is therefore a desire to have a coupling device or mounting plate in which the securing devices for tools and other devices are not jammed against one another during use.

An object of the present invention is therefore to solve the above problems and produce a harness with a mounting plate which offers a more ergonomic working position in a harness, with a better facility for handling tools, winches, lowering gears and other devices.

### DISCLOSURE OF INVENTION

The invention aims to solve the problems which have been specified above. The problems are solved by a mounting plate intended for use together with a harness. The mounting plate and the harness are preferably designed for use by a human being. The mounting plate comprises a first opening. The invention is characterized in that the mounting plate, via the first opening, is arranged in a first part of the harness in such a way that the mounting plate, when in use, juts out essentially at right angles from the body of a user. The mounting plate further advantageously comprises a second opening. The harness is advantageously, via the first part, arranged in the first opening and, via a second part of the harness, arranged in the second opening.

In the following description of the invention, the term “receive” is used in describing the function of the various openings. By receive is here meant that the opening can be passed through by a device and that the device can be secured, contained, arranged or accommodated in the opening.

According to the invention, the mounting plate is integrated in the harness and replaces the coupling device, the snap hook and the mounting plate described in the prior art. According to the invention, the harness is secured directly in the mounting plate without any intermediate links (for example a coupling device in the form of a D-ring), thereby producing a lower securement point for tools and devices which are to be placed by the mounting plate.

By harness is meant a device consisting of straps intended for strapping tightly around a user. A harness advantageously comprises a leg strap around each thigh of the user and a waist part around the waist of the user. The waist part is further advantageously connected to the leg parts by additional straps on the rear side of the body of the user. The leg parts can further be connected one to the other by a connecting strap on the front side of the body of the user.

According to one embodiment of the invention, the mounting plate advantageously comprises a third opening at a distance from the first opening and the second opening. The third opening can expediently be used as a securement point for the securement of tools and/or rope.

The third opening is advantageously arranged at a first distance in the vertical direction from the first opening and at a first distance in the horizontal direction from the second opening. The second opening is further advantageously arranged at a second distance in the vertical direction from the first opening.

The mounting plate can further be configured with additional openings. The additional openings can advantageously be used as a securement point for the securement of tools or rope. The additional openings can advantageously lie in a row along the contour of the mounting plate on that side of the mounting plate which faces away from the body of a user during use.

According to one embodiment of the invention, the additional openings lie arranged one above the other at various distances from the body of the user, which offers the advantage that devices can be secured in the various openings without the securing gears/securing devices of the devices jamming together. The securing gear/securing devices will lie one on top of the other. Because the openings lie one on top of the other and the mounting plate has an extent out from the body of the user, further advantages are obtained through the absence of any lateral load upon the mounting plate.

A lower securement point advantageously gives a lower height to the tool and/or the device for the user. The integration of the mounting plate in the harness together with the projecting characteristic of the mounting plate further offers the advantage that the mounting plate does not turn in such a way that the genitalia of the user are at risk of being pinched.

The mounting plate juts out from the body in such a way, moreover, that the securement points for tools and securement points for the rope from which the user is to hang are away from the body. This improves the facilities for the user to work with tools and otherwise improves the ergonomic situation of the user.

According to one embodiment of the invention, the mounting plate is plane in its extent and advantageously has a first edge part on the lower side of the mounting plate, viewed from the plumb line, which extends essentially out from the body of a user, and a second edge part, which, when the safety device is in use, extends in the direction along the body of a user. The first opening is advantageously placed along the first edge part and the second opening is advantageously placed along the second edge part.

In another embodiment of the invention, the mounting plate can be equipped with a separate fastening device for the second opening. The fastening device can, for example, be arranged at an angle to the projecting part of the mounting plate, along and against the second edge part. The fastening device can then, when in use, advantageously have an extension substantially parallel with the body of a user. The second opening can in this case consist of two openings on either side of that part of the mounting plate which juts out substantially at right angles from the body of the user.

Correspondingly, a fastening device can be arranged against the first edge part, in which the first opening is arranged in the fastening device, for example in the form of an opening on either side of that part of the mounting plate which juts out essentially at right angles from the body of the user.

As previously mentioned, the harness can comprise leg straps and a connecting strap between the leg straps, as well as a two-piece waist strap. The connecting strap advantageously consists of a strap which, in the end sections, is fastened in the leg straps. According to any of the aforementioned embodiments, the first opening is advantageously arranged to receive the connecting strap and the second opening is advantageously arranged to receive the waist strap. The straps are advantageously of such a nature that their width is greater than their thickness.

The invention also relates to a safety device comprising a mounting plate and a harness, the mounting plate comprising a first opening. The safety device is characterized in that the mounting plate comprises a second opening, in which the harness, via a first part, is arranged in the first opening and, via a second part, is arranged in the second opening. The mounting plate is therefore advantageously integrated in the harness in such a way that the mounting plate, when in use, juts out essentially at right angles from the body of a user.

The aforementioned advantages with the mounting plate also apply to the safety device. Further advantages with the invention will be described below in the description of various embodiments.

One example of a possible configuration of a mounting plate is given below in the form of a number of data:
Height: 40-300 mm
Width: 3-50 mm
Depth: 20-200 mm
Number of openings: 2-14.

The size of the first and second opening can be varied according to choice in such a way that the straps can be received and appropriate strength is obtained. Appropriate strength relates to the norms laid down by the authorities for a safety harness with mounting plate to be allowed to be used in a certain activity. The first and the second opening are preferably configured as slots. By slot is meant a long and narrow opening which can have bevelled short ends. The third opening and the additional openings are preferably configured with circular or oval geometries.

The diameter of the third opening is advantageously ca. 15 mm or larger, or of such a size that a lockable snap hook can be passed through the opening a full turn. The diameter of the third opening can therefore be varied in dependence on the size of the snap hook.

The mounting plate is advantageously curved in such a way that a lower part forms a substantially rectangular/trapezoidal part and an upper part forms a curved tapered part which ends in a snub-nosed tip. The upper part starts from the upper side of the rectangle. The opposite lower part of the rectangle is limited by the first edge part. That part of the rectangle/trapezium which faces toward the body of the user is limited at least partially by the second edge part. That part of the rectangle which is opposite the second edge part faces away from the user during use. The curved part is curved in such a way that the tip of the curved part sticks out beyond the extended limit line of the rectangle in the vertical direction on that side of the rectangle which faces away from the user during use. The curved configuration means that the mounting plate does not disturb the user during use. As an example can be cited that the mounting plate must not stick into the stomach or chest of the user when the user bends forward. The angle between the first opening and the second opening therefore has a certain importance for the configuration of the mounting plate. The angle should be such that the configuration of the mounting plate affords the user a comfortable working position without the mounting plate disturbing him in such a way as has been mentioned above.

When the mounting plate is in use, a rope or a tool is advantageously fixed in the third opening, which advantageously is placed at a distance from the tip of the curved part. Such a securement is advantageously made with a securing device/securing gear in the form of a snap hook, but can also consist of an eyelet arranged in the rope. A fourth opening can advantageously be placed in connection with the tip of the curved part. One advantage with this is that the fourth opening sticks out beyond the plumb line formed by the rope and the snap hook secured in the rope. The fourth opening is therefore free to be used to secure additional tools or rope. This differs from the case where the additional openings lie in a row in the vertical direction, since the fourth opening would then have been fully or partially covered by the securing device/securing gear, i.e. the snap hook or the rope.

A further advantage with the invention is that the mounting plate further can move freely about the third opening, with the securing gear as the hinge. A user can then, by leaning back, make the mounting plate rotate about the securing gear in such a way that the fourth opening moves from one side of the plumb line to the other side of the plumb line. A user can therefore determine the side of the plumb line on which the fourth opening shall be located.

The advantageous aspect of the invention can therefore be achieved by configuring a mounting plate which, during use, juts out from the body of a user within the framework of the measurements which have been specified above.

### BRIEF DESCRIPTION OF DRAWINGS

The invention will be described below in a number of embodiments with the aid of figures.

FIG. 1 shows in diagrammatic representation a side view of a mounting plate and a harness, in use, according to the prior art.

FIG. 2 shows in diagrammatic representation a side view of a mounting plate and a harness, in use, according to the invention.

FIG. 3 shows in diagrammatic representation a side view of a mounting plate according to the invention.

FIG. 4 shows in diagrammatic representation a front view of a mounting plate and a harness, in use, according to the invention.

FIG. 5 shows in diagrammatic representation a rear view of a harness, in use, according to the invention.

### PREFERRED EMBODIMENTS

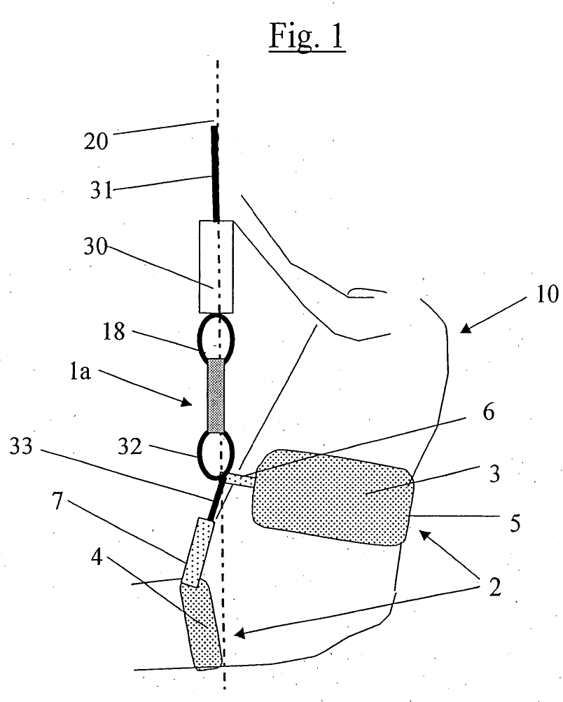

FIG. 1 shows in diagrammatic representation a side view of a mounting plate 1a and a harness 2, in use, according to the prior art. The mounting plate 1a consists of a flat unit with openings cut in the unit. The mounting plate 1a according to FIG. 1 has an extent along the body of a user 10. The harness 2 is configured with a waist part 3, two leg parts 4 and a front connecting strap 7 between the leg parts 4.

The waist part 3 consists of a back part 5 and a front part 6. The front part 6 can consist of two waist straps intended to close the waist part 3 around the body of the user 10. The waist straps are advantageously equipped with devices which form a reclosable joint, for example a clasp, Velcro fastening or a combination thereof, or some other suitable device which forms reclosable joints. The waist part 3 can also be configured in one piece with an adjustable device for altering the size of the waist part around the body of a user.

The leg parts 4 each consist of a strap which passes around the thigh of a user 10 and which advantageously can be reclosable, adjustable, or the opening in which can have a specific size. Both thighs are encircled by such leg parts 4.

The leg parts 4 are advantageously connected one to the other by the front connecting strap 7 on the front side of the user 10. The front connecting strap 7 can be attached to the leg parts 4 by an eyelet which receives the leg parts or by the front connecting strap 7 being firmly anchored to the leg parts, for example by gluing and/or by sewing.

FIG. 1 illustrates that the waist part 3 and the front connecting strap 7 are connected by a coupling device 33. Such a coupling device 33 can consist of a so-called “D-ring”, or a special strap, or some other suitable device which can permanently connect the waist part 3 and the front connecting strap 7. The coupling device 33 can be affixed to the harness by the harness having been sewn around the coupling device or by the coupling device having been passed through openings present in the harness, after which the coupling device has been permanently closed, for example by welding or soldering.

FIG. 1 illustrates that the coupling device 33 is fixed in a securing device/securing gear in the form of a snap hook 32. The snap hook 32 is, in turn, fixed in the mounting plate 1a. This can be done by the snap hook 32 being opened and introduced into the opening in the coupling device 33, after which the snap hook is introduced into an opening present in the mounting plate 1a. FIG. 1 also reveals the drawback with the prior art and the aforementioned sequence, in which the coupling device 33 lies along the front side of the body of the user 10. Because of this, the snap hook 32 is secured in the coupling device 33 in such a way that the snap hook 32 juts out from the body of the user, which, in turn, means that the mounting plate 1a is secured in the snap hook 32 in such a way that the mounting plate 1a has an extent substantially parallel with the body of the user. The snap hook 32 thereby threatens to dig into the body of the user when the user bends forward or stretches. Furthermore, the plane positioning of the mounting plate 1a produces securement points which can create an uneven loading of the mounting plate when tools, etc, are applied.

FIG. 1 illustrates that an additional securing device/securing gear 18 is secured in the mounting plate 1a. The additional securing gear 18 is further secured in a tool 30. The tool 30 can be a winch or some other tool. The tool 30 is, in turn, secured in a rope 31. The user 10 therefore hangs from the rope 31 by way of the tool, the securing gear 18, the mounting plate 1a, the snap hook 32 and the coupling device 33. The forces absorbed by the user 10 in the hanging position are distributed via the coupling device 33 to the leg parts 4 and the waist part 3.

FIG. 1 reveals that the sequence involving the tool, the securing gear 18, the mounting plate 1a, the snap hook 32 and the coupling device 33 together produces an unsuitable working height for the user, since the arms of the user need to be raised above shoulder/head height in order to reach the rope.

FIG. 1 shows a plumb line 20, to which reference will be made later. The plumb line has the purpose of showing what is up and down in relation to the earth's attraction and also provides an indication of how the centre of gravity of the user relates to the rope. The head of the user is always up in the adjoining description.

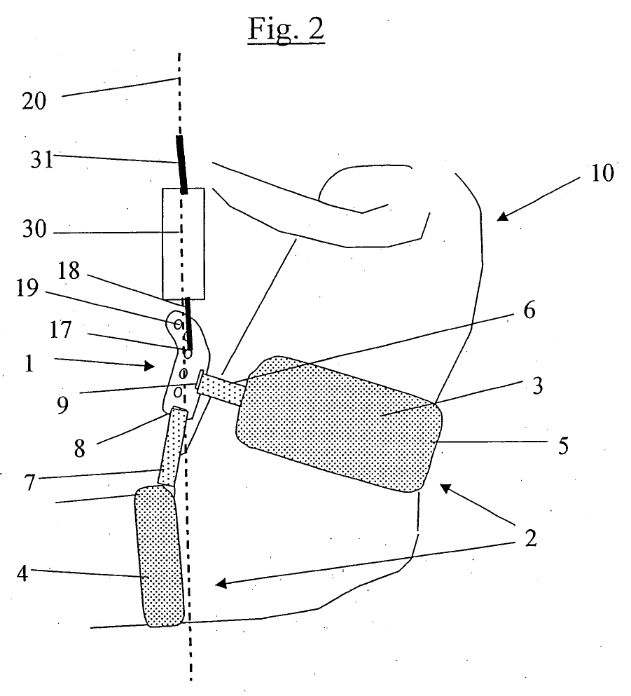

FIG. 2 shows in diagrammatic representation a side view of a mounting plate 1 and a harness 2, in use, according to the invention. The difference between FIG. 1 and FIG. 2 consists in the mounting plate 1 according to the invention. FIG. 2 illustrates a mounting plate 1 which juts out from the body of a user 10 and FIG. 1 illustrates a mounting plate 1a which lies level with (parallel with) the body of a user 10. It can further be seen that the mounting plate 1 according to the invention (FIG. 2) replaces the coupling device 33, the snap hook 32 and the mounting plate 1a which are shown in FIG. 1. According to the invention, moreover, the mounting plate 1 is directly secured in the harness 2.

FIG. 2 illustrates that the mounting plate 1 comprises a first opening 8 and a second opening 9. The harness 2 is preferably arranged in the first opening 8 and in the second opening 9 in such a way that the mounting plate 1, when in use, juts out essentially at right angles from the body of a user 10.

FIG. 2 illustrates that the mounting plate 1 is plane in its extent and advantageously has a first edge part 11 and a second edge part 12. When the mounting plate 1 is in use, the first edge part 11 is arranged on the down side of the mounting plate 1, viewed from the plumb line 20, and extends out from the body of the user 10, and the second edge 12 extends in the direction along the body of the user 10. The first opening 8 is advantageously placed along the first edge part 11 and the second opening 9 is advantageously placed along the second edge part 12.

The first opening 8 is advantageously arranged to receive the front connecting strap 7 and the second opening 9 is advantageously arranged to receive a part of the waist strap which constitutes the front part 6 of the waist part. To this end, the first and the second opening 8, 9 are advantageously configured as slots.

The mounting plate 1 juts out from the body in such a way that fastening points for tools and fastening points for the rope from which the user is to hang are prominent from the body. This improves the facilities for the user 10 to work with tools and otherwise improves the ergonomic situation of the user 10. To this end, the mounting plate advantageously comprises a third opening 17, which can receive securing devices/securing gears 18 for tools and securing devices/securing gears for rope.

FIG. 2 illustrates that the mounting plate 1 is advantageously curved in such a way that a lower part 13 forms a substantially rectangular/trapezoidal part and an upper part 14 forms a curved tapered part which ends in a snub-nosed tip 15. The upper part 14 starts from the upper side of the rectangle. The opposite lower part 13 of the rectangle is limited by the first edge part 11 and that part of the rectangle/trapezium which faces toward the body of the user 10 is limited at least partially by the second edge part 12. That part of the rectangle which is opposite the second edge part 12 faces away from the user during use. The curved part is curved in such a way that the tip 15 of the curved part sticks out beyond the plumb line 20 viewed from the prospective of the user 10.

When the mounting plate 1 is in use, a rope or a tool 30 is fixed in the third opening 17, which advantageously is placed at a distance from the tip of the curved part. Such a securement is advantageously made with a securing device 18 in the form of a snap hook, but can also consist of an eyelet arranged in the rope or another suitable securing device.

FIG. 2 illustrates that a fourth opening 19 can advantageously be placed in connection with the tip of the first opening 8. One advantage with the mounting plate 1 according to the invention is that the fourth opening 19 sticks out beyond the plumb line 20 formed by the rope and the snap hook secured in the rope. The fourth opening 19 is therefore free to be used to fix additional tools or rope. This differs from the case where the fourth opening 19 would have lain in line with the third opening 17 in the vertical direction, since the fourth opening 19 would have been fully or partially covered by the securing device 18 (i.e. covered by the snap hook or the rope).

FIG. 2 illustrates a tool 30 secured in the third opening 17 in the mounting plate 2 by a securing device 18. The tool 30 can be a winch or the like and the securing device 18 can be a snap hook or the like. FIG. 2 illustrates an advantage with the present invention, in which the mounting plate 1 is directly secured, or integrated, in the harness. Because the mounting plate 1 is directly secured in the harness 1, the distance between the harness 2 and the tool 30 is reduced. This should be compared with the greater distance between the harness 2 (the coupling device 33) and the tool 30 which is shown in FIG. 1. The reason for the reduction in distance according to the invention is, as previously mentioned, that the mounting plate 1 replaces the coupling device 33, the snap hook 32 and the mounting plate 1a. The advantage with this is shown in FIG. 2, in which the user can reach the rope 20 above the tool 30 without stretching his arms above the shoulders/the head.

Further advantages with the mounting plate are that it can move freely about the third opening 17, with the securing device 18 (for example the snap hook) as the hinge. A user 10 can then, by leaning back, make the mounting plate 1 rotate about the snap hook in such a way that the fourth opening 19 moves from one side of the plumb line 20 to the other side of the plumb line 20. A user 10 can therefore determine the side of the plumb line 20 on which the fourth opening 19 shall be located.

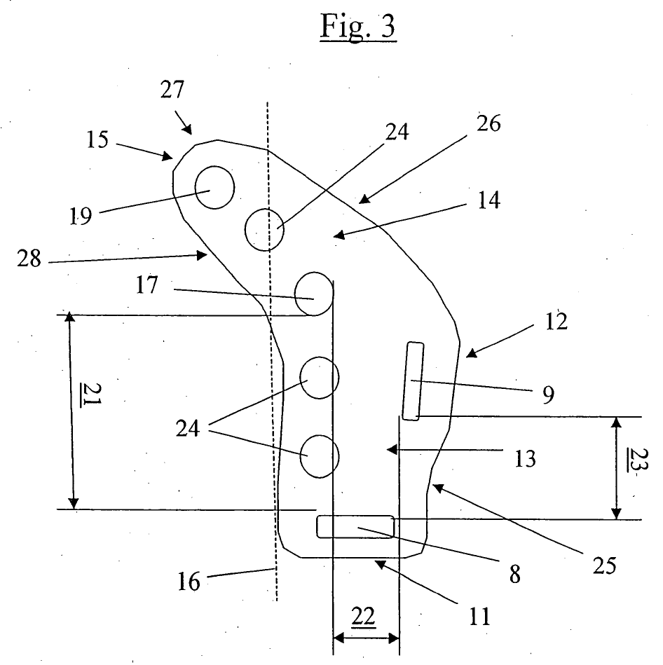

FIG. 3 shows in diagrammatic representation a side view of a mounting plate 1 according to the invention. FIG. 3 illustrates that the mounting plate 1 advantageously comprises the third opening 17 at a distance from the first opening 8 and the second opening 9. The third opening 17 can expediently be used for the securement of tools and/or rope.

The third opening 17 is advantageously arranged at a first distance in the vertical direction 21 from the first opening 8 and at a first distance in the horizontal direction 22 from the second opening 9. The second opening 9 is further advantageously arranged at a second distance in the vertical direction 23 from the first opening 8. The positioning and configuration of the first and the second opening 9 is of importance to the balance of the harness 2 during use.

The first opening 8 absorbs loads essentially in the vertical direction from the legs via the leg openings and the second opening 9 absorbs loads essentially in the horizontal direction from the back via the waist part. The loads in the vertical direction are usually greater than the loads in the horizontal direction. As previously mentioned, the third opening 17 is intended to receive tools or rope. Regardless of whether it is a tool or a rope which is secured in the mounting plate, the third opening 17 is intended for the user to hang from. If a tool, for example a motor-driven winch, is arranged in the mounting plate 1, then the tool hangs from the rope from which the user hangs.

The first, second and third opening 8, 9, 17 therefore form a triangle if lines are drawn between the various openings, which triangle expediently balances loads during use in such a way that the mounting plate 1 juts out from the body and does not capsize during use.

FIG. 3 illustrates that the first and the second opening 8, 9 are substantially rectangular with rounded corners, i.e. in the form of slots. The rectangular openings are intended to receive straps, the width of which exceeds their height. The width of the straps, together with the configuration of the first and second opening 8, 9, produces the desired stability and load distribution of the mounting plate 1. The first and the second opening 8, 9 do not need to be of rectangular configuration, but can have another suitable geometry for this purpose. An example of such a geometry is triangular, in which one side of the triangle is intended to bear against the strap which has been applied in the opening.

In FIG. 3, the third opening 17 is configured with a circular geometry, which offers advantages in receiving snap hooks and rope, etc. A circular geometry is not essential, but what is crucial is that rope or other securing devices 18 are secured in such a way that there is no wear upon the rope. The third opening 17 can therefore be configured with elliptical geometry or a triangular geometry with rounded corners.

FIG. 3 illustrates the fourth opening 19 positioned on the tip 15 of the mounting plate 1. In FIG. 3, the fourth opening 19 is advantageously placed outside the extended limit line 16 of the rectangle in the vertical direction, on that side of the mounting plate 1 which faces away from the user 10. Such a positioning of the fourth opening 19 has the advantage that a user can easily reach a securement point for a tool when the user is hanging in working position, as previously discussed.

The mounting plate 1 can further be configured with additional openings 24. FIG. 3 illustrates the additional openings 24, which can advantageously be used in securing tools or rope. FIG. 3 illustrates that the additional openings 24 can advantageously lie in a row along the contour of the mounting plate on that side of the mounting plate 1 which faces away from the body of a user 10 during use. The additional openings 24 do no need to be aligned as shown in FIG. 3, but can be arranged in the mounting plate 1 in some other suitable manner, for example in two rows, a zigzag pattern, or one row with an additional opening or two on one or other side of the row of openings.

FIG. 3 illustrates that the first edge part 11 of the mounting plate is relatively straight and extends substantially horizontally from the body of the user. The first edge part 11 is configured in such a way that the genitalia of a user are not exposed to such a load that discomfort is felt when a user uses the mounting plate 1 and the harness 2. This is especially important where a user, moreover, uses a so-called boatsman's chair or where a user wears a harness when driving a car.

The second edge part 12 of the mounting plate is relatively straight and extends substantially perpendicularly. The second edge part 12 is configured to follow the contour of the body, thereby reducing the risk of exposure of the user 10 to point loads when the mounting plate presses against the body of the user 10.

FIG. 3 further illustrates that the mounting plate 1 has a third edge part 25 between the first and the second edge part 11, 12, which faces toward a user 10 during use. According to FIG. 3, the third edge part 25 is curve-shaped and concave from the perspective of the user 10 during use. Like and together with the second edge part 12, the third edge part 25 is configured to follow the contour of the body, thereby reducing the risk of exposure of the user 10 to point loads when the third edge part 25 of the mounting plate 1 presses against the body of the user 10.

FIG. 3 illustrates that the mounting plate 1 has a fourth edge part 26 which is curve-shaped and convex from the perspective of the user 10 during use. The fourth edge part 26 starts from the end of the second edge part 12 and is arranged to face toward the user 10 during use. The fourth edge part 26 is configured to partially follow the contour of the body, thereby reducing the risk of exposure of the body to point loads when the mounting plate presses against the body of the user. The fourth edge part 26, moreover, is configured to bend outward and away from a user when a user 10 sits with a relatively straight back. This allows the user to bend heavily forward without him being exposed to point loads from the fourth edge part 26 of the mounting plate 1. The fourth edge part 26 is therefore arranged to follow the body contour of the user 10 when the user bends forward.

FIG. 3 illustrates that the mounting plate 1 has a sixth edge part 28, which is curve-shaped and convex from the perspective of the user 10 during use. The sixth edge part 28 faces away from the user during use and ends at the start of the first edge part 11. The sixth edge part 28 is configured in such a way that the risk of catching from rope and tools in the mounting plate during lowering operations is minimized.

FIG. 3 illustrates that the mounting plate 1 has a fifth edge part 27, which is curve-shaped and convex from the perspective of the user 10 during use. The fifth edge part 27 is arranged between the fourth edge part 26 and the sixth edge part 28. The outermost part of the sixth edge part 28 consists of the snub-nosed tip 15 specified above. The rounded shape of the sixth edge part 28 is arranged to minimize the risk of catching of tools and rope during lowering.

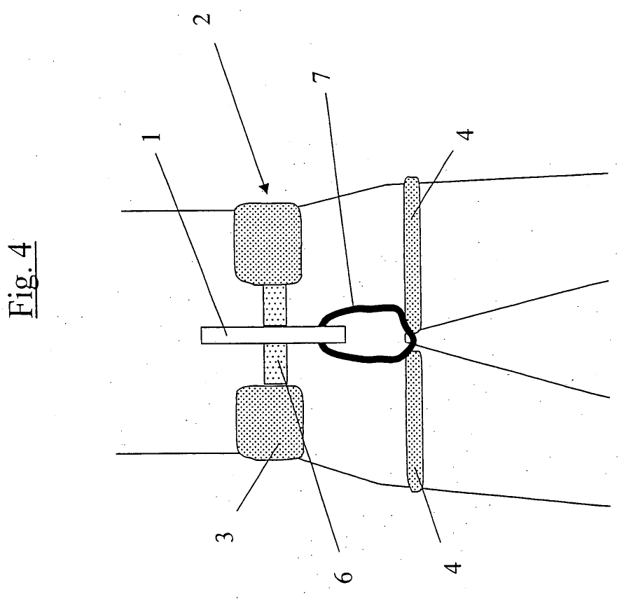

FIG. 4 shows in diagrammatic representation a front view of a mounting plate 1 and a harness 2, in use, according to one embodiment of the invention. FIG. 4 illustrates how the front connecting strap 7 connects the leg parts 4 one to the other and to the mounting plate 1.

The positioning of the first and second opening 8, 9 of the mounting plate 1 gives the device a good balance. The first opening 8 absorbs loads from the leg parts and the second opening 9 absorbs loads from the waist part 3.

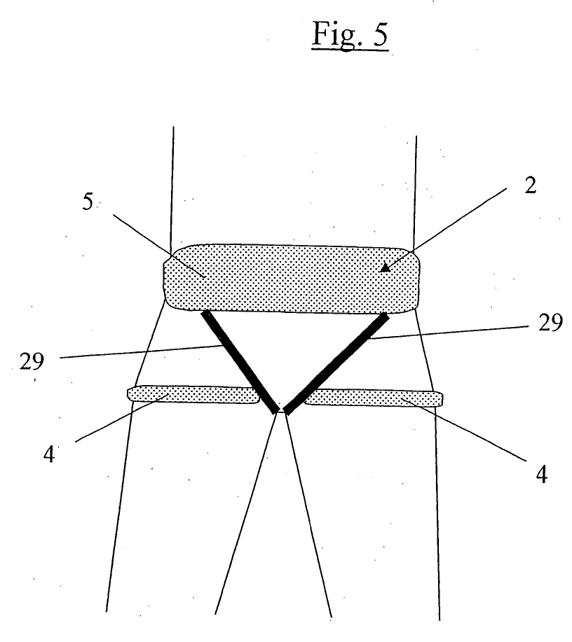

FIG. 5 shows in diagrammatic representation a rear view of a harness, in use, according to the invention. FIG. 5 illustrates that the leg parts 4 are advantageously connected one to the other by a rear connecting strap 29 on the rear side of a user 10. The rear connecting strap 29 can be attached to the leg parts 4 by an eyelet which receives the leg parts, or by the front connecting strap 7 being firmly anchored to the leg parts, for example by gluing or by sewing. The rear connecting strap 29 further connects the leg parts 4 to the back part 5 of the waist part 3.

The invention is not limited to what has been shown in the various embodiments, but can be varied within the scope of the adjoining patent claims. As examples can be cited that the mounting plate 1 can have a different geometrical configuration from what has been shown, for example in the form of a trapezium with the second opening 9 on that side of the mounting plate which faces toward a user, and in which the first opening 8 is arranged on the lower side connecting the two other sides. The upper tip of the trapezium advantageously faces away from the user and the lower tip of the trapezium faces toward the user. The lower tip is advantageously bevelled in such a way that the mounting plate follows the body contour of the user, in a manner similar to that mentioned above. The third opening 17 is preferably arranged somewhere remote from the first opening 8 and the second opening 9. The fourth opening can be placed, for example, close to the upper tip.

The mounting plate 1 can further be configured essentially as a triangle with a substantially right angle, in which one short side extends alongside the body of the user 10 and in which the second short side extends out from the body of the user 10 and in which the hypotenuse extends from the lower part 13 of the mounting plate, by the body of the user 10, up and out toward the end point of the second short side. With the triangular configuration of the mounting plate 1, the first opening 8 is placed near to the lower apex of the triangle between the hypotenuse and the short side which extends along the body of the user 10. The second opening 9 is preferably placed along the short side which extends along the body of the user 10. The third opening 17 is preferably arranged somewhere remote from the first opening 8 and the second opening 9. The fourth opening can be placed, for example, close to the second apex of the triangle, i.e. where the other short side, extending out from the body of the user 10, meets the hypotenuse.

With both the trapezoidal and the triangular configuration, it is nevertheless important to point out that the mounting plate 1 is arranged in such a way that the mounting plate 1 does not disturb the user during use. As an example can be cited that the mounting plate 1 must not stick into the stomach of the user 10 when the user bends forward.

The first opening 8 can consist of two or more openings intended to receive one or more straps, having the same purpose as has been indicated above in the description of the first opening 8.

The second opening 9 can consist of two or more openings intended to receive one or more straps, having the same purpose as has been indicated above in the description of the second opening 9.

In another embodiment of the invention, the mounting plate can be equipped with a separate fastening device for the second opening. The fastening device can be arranged, for example, at an angle to the projecting part of the mounting plate, along and against the second edge part. The fastening device can then, when in use, advantageously have an extension substantially parallel with the body of a user. The second opening can then consist of two openings on either side of that part of the mounting plate which juts out substantially at right angles from the body of the user. The opening can be in the form of a slot, either having an oval or circular geometry.

Correspondingly, a fastening device can be arranged against the first edge part, in which the first opening is arranged in the fastening device, for example in the form of an opening on either side of that part of the mounting plate which juts out essentially at right angles from the body of the user. The opening can be in the form of a slot or can have an oval or circular geometry.

1-14. (canceled)

15. Mounting plate (1) intended for use together with a harness (2), the mounting plate (1) comprising a first opening (8) and a second opening (9), wherein a first part (7) of the harness (2) being arranged in the first opening (8) and a second part (6) of the harness (2) being arranged in the second opening (9), characterized in that the mounting plate (1) is plane in its extent and that, via the first opening (8) and the second opening (9), is arranged in the harness (2) in such a way that the mounting plate (1), when in use, juts out essentially at right angles from the body of a user (10) and extends in a vertical direction and where the second opening (9) is arranged so as to be located, when in use, at a second distance in the vertical direction (23) from the first opening (8).

16. Mounting plate (1) according to claim 15, characterized in that the mounting plate (1) comprises a third opening (17) at a distance from the first opening (8) and the second opening (9), the securing devices (18) for tools or rope being intended to be arranged in the third opening (17).

17. Mounting plate (1) according to claim 16, characterized in that the third opening (17) is arranged so as to be located, when in use, at a first distance in the vertical direction (21) from the first opening (8).

18. Mounting plate (1) according to claim 16, characterized in that the third opening (17) is arranged so as to be located, when in use, at a first distance in the horizontal direction (22) from the second opening (9).

19. Mounting plate (1) according to claim 15 characterized in that the mounting plate (1) is configured with additional openings (24).

20. Mounting plate (1) according to claim 15, characterized in that the mounting plate (1), when in use, has a first edge part (11) on the down side of the mounting plate (1), viewed from the plumb line (20), having an extent substantially out from the body of a user, and a second edge part (12), which extends in the direction along the body of a user (10), the first opening (8) being placed along the first edge part (11) and the second opening (9) being arranged along the second edge part (12).

21. Mounting plate (1) according to claim 15, characterized in that the first and/or the second opening is/are configured in the form of a slot, intended to receive and comprise first and second parts (6, 7) forming part of the harness (2).

22. Mounting plate (1) according to claim 16, characterized in that the third and/or a fourth opening is/are configured with a circular or oval geometry.

23. Mounting plate (1) according to claim 15, in which the harness (2) comprises leg straps (4) and a front connecting strap (7) between the leg straps, as well as a two-piece waist strap (6), characterized in that the first opening (8) is arranged to receive the front connecting strap (7) and the second opening (9) is arranged to receive the waist strap (6).

24. Mounting plate (1) according to claim 15, characterized in that the mounting plate (1) and the harness (2) are designed for use by a human being.

25. Safety device comprising a mounting plate (1) intended for use together with a harness (2), the mounting plate (1) comprising a first opening (8) and a second opening (9), wherein a first part (7) of the harness (2) being arranged in the first opening (8) and a second part (6) of the harness (2) being arranged in the second opening (9), characterized in that the mounting plate (1) is plane in its extent and that, via the first opening (8) and the second opening (9), is arranged in the harness (2) in such a way that the mounting plate (1), when in use, juts out essentially at right angles from the body of a user (10) and extends in a vertical direction and where the second opening (9) is arranged so as to be located, when in use, at a second distance in the vertical direction (23) from the first opening (8).

26. Mounting plate (1) according to claim 17, characterized in that the third opening (17) is arranged so as to be located, when in use, at a first distance in the horizontal direction (22) from the second opening (9).
